(19) United States
(12) Patent Application Publication
(10) Pub. No.: US 2007/0137050 A1
(43) Pub. Date: Jun. 21, 2007

(54) Razor blades and compositions and processes for the production of razor blades

(75) Inventors: Yiming Xu, Milford, CT (US); William E. Vreeland, Shelton, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/442,493

(22) Filed: May 25, 2006

Related U.S. Application Data
(60) Provisional application No. 60/685,714, filed on May 27, 2005.

(51) Int. Cl. B26B 21/54; B21K 11/00

(52) U.S. Cl. 30/346.54; 76/104.1

(57) ABSTRACT

Razor blades for use in wet shave razors are produced from a precipitation hardenable ferrous composition having an austenitic structure and being supersaturated in certain elements, by a cold rolling process which converts most of the austenite to martensite, followed by a heat treatment process which causes the precipitation of strengthening particles to produce a corrosion resistant material having a hardness in excess of 600 HV.

### CROSS REFERENCE TO RELATED APPLICATION

This application claims the benefits of U.S. Provisional Patent Application Ser. No. 60/685,714, filed on May 27, 2005, the contents of which are incorporated herein by reference in their entirety.

### FIELD OF THE INVENTION

This invention relates to razor blades for use in wet shave razors, to compositions for making razor blades, and methods for use with these compositions to produce razor blades for wet shave razors having improved corrosion resistance and a high hardness.

### BACKGROUND OF THE INVENTION

Razor blades for wet shave razors are commonly produced from steel containing about 0.7% carbon by weight and about 12% chromium by weight. A conventional process for producing these razor blades is to hot roll and then cold roll a starting material to the desired razor blade thickness, which is usually between about 0.003 inches and 0.005 inches. This rolled material is then heat-treated to convert the as-rolled microstructure to an austenite microstructure. Following heat treatment the material is quenched to at least partially convert the austenite to a martensitic microstructure. The martensitic microstructure is too hard and brittle for use in razor blade applications, so the material is further heat treated at an intermediate tempering temperature to partially transform the martensite thereby obtaining a tougher, softer microstructure. In this conventional material the increased hardness and toughness which results from the heat treatment process is a consequence of the formation and modification of carbon-containing phases in the material. Most of the carbon-containing phases formed in this steel contain chromium, and typically about 4 wt. % chromium is in the form of carbides, leaving about 8 wt. % chromium remaining for corrosion reduction. This amount of chromium reduces but does not eliminate corrosion resulting from shaving conditions.

The above-described chromium carbon steel material has historically been used in the manufacture of razor blades and has exhibited a proclivity towards corrosion. Corrosion is unappealing to the user and degrades razor performance. Consequently, there have been many efforts made to provide a hard, tough material suitable for razor blade applications which is corrosion resistant.

Attempts to improve the corrosion resistance of razor blade steel through additions of more chromium have been largely unsuccessful due to the fact that when sufficient chromium to eliminate corrosion is added, the steel cannot be heat treated to a sufficient hardness for use in razor blade applications.

Precipitation hardening stainless steels have been developed which do not rely on carbon-containing phases for mechanical properties. Such steels are described in patents U.S. RE 36,389, U.S. Pat. No. 5,632,826, U.S. Pat. Nos. 5,759,308, and 6,475,307 which are expressly incorporated herein by reference.

Many attempts have been made to modify the surface of carbon steel razor blades by the application of coatings to retard corrosion and/or to reduce friction. Coatings such as chromium, precious metals, alloys based on chromium, and mixtures thereof, ceramics, diamond-like carbon, amorphous diamond, and polymers such as Teflon™ Krytox 1000™, and Dryfilm LXE™ have been used (Teflon, Krytox 1000, and Dryflim LXE are products of the DuPont Corporation).

There remains a need and desire in the industry to provide razor blades which are hard and inherently corrosion resistant.

Based on the foregoing, it is the general object of the present invention to provide a material useful for the production of razor blades that overcomes the problems and drawbacks associated with the prior art.

### SUMMARY OF THE INVENTION

The present invention resides in one aspect in a low carbon (less than about 0.1%) precipitation hardening stainless steel useful for making razor blades for wet shave razors, containing substantial amounts of chromium and nickel for corrosion resistance and containing at least one element selected from the group consisting of titanium, aluminum, copper, silicon, and molybdenum provided as a starting material. Elements of a second group (titanium, aluminum, copper, silicon and molybdenum) are present as strengthening precipitates which replace and perform the functions of the carbon-containing precipitates that provide strengthening and hardness in conventional chromium-containing carbon steels.

The above-described starting material also displays transformation-induced plasticity which means that if the starting material is heat treated so that it exhibits an austenite structure, it can be deformed, for example, by cold rolling, to at least partially convert the austenite structure to the harder, tougher, martensite structure. Following the transformation of the austenite to martensite, the material can be heat treated to cause the formation of a strengthening dispersion of precipitates which contain one or more of the materials titanium, aluminum, copper, silicon and molybdenum. This precipitation hardening stainless steel in combination with appropriate process steps can be used to produce a razor blade material having a hardness in excess of 600 HV, and preferably in excess of 800 HV (measured at an applied load of 1 Kg) in combination with a high resistance to corrosion in shaving applications.

One advantage of the present invention over the prior art resides in the composition having improved corrosion resistance. Improved corrosion resistance results from the presence of an increased amount of non-carbide chromium. Because less chromium is bound in a carbide structure, more chromium is available to provide resistance to the formation of oxides that form the basis for corrosion.

### BRIEF DESCRIPTION OF THE DRAWINGS

FIG. 1 is a graphical representation illustrating the hardness achieved for different heat treat cycles for 85% cold reduced material.

FIG. 2 is a graphical representation illustrating the hardness achieved for different heat treat cycles for 97% cold reduced material.

### DETAILED DESCRIPTION OF THE PREFERRED EMBODIMENTS

The present invention relates to razor blades and to compositions and processes for producing razor blades for wet shave razors. The resultant razor blades have a particular composition and are produced using a particular processing sequence.

Table I presents broad and preferred compositions for use in manufacturing razor blades of the invention. The percentage values in Table I are in weight percent (wt. %) as are all other percent values in this application unless otherwise expressly indicated.

TABLE I

| | Broad Range | Preferred Range |
|---|---|---|
| C | 0.1 max | 0.015 max |
| Si | 0.7 max | 0.5 max |
| Mn | 1.0 max | 0.1-0.5 max |
| Cr | 10-14 | 11.5-12.5 |
| Ni | 7-11 | 8.75-9.75 |
| Mo | 0.5-6 | 3.75-4.25 |
| Ti | 0.4-1.4 | 0.7-1.1 |
| Cu | 0.5-4 | 1.8-2.2 |
| Al | 0.05-0.6 | 0.25-0.45 |
| Co | 0-9 | <5 |
| Ta | 0.1 max | <0.1 |
| Nb | 0.1 max | <0.03 |
| V | 0.1 max | <0.1 |
| W | 0.1 max | <0.1 |
| Fe (including normal | Balance | Balance |
| impurities up to 0.5) | | |

(values shown in wt. %)

In a razor blade of the present invention having a composition as indicated in Table I, the carbon content is limited so that it is well below that used in conventional razor blade steels. In one embodiment, the carbon content is less than about 0.015% and preferably less than about 0.010%. Because in a carbide compound the effectiveness of the carbon is limited in its ability to precipitate to provide a strengthening effect, the term “carbon content” as used herein is exclusive of the carbon contents of any carbides present. By limiting the carbon content as such, the use of carbide compounds to provide the carbon content is precluded or at least substantially limited.

In the preferred composition, neither silicon nor manganese is required. However, if either silicon or manganese is present in the composition, they may contribute to the formation of certain strengthening precipitates. As used herein, the term “strengthening precipitate” indicates a metal-containing phase that precipitates from a supersaturated solution of an alloy in which the precipitation occurs during the slow cooling of the alloy because. the solubility of the metal of the metal-containing phase decreases with decreasing temperature. In the present invention, the contribution of silicon or manganese to the formation of strengthening precipitates is effected by the homogenous nucleation of metal atoms to form aggregates having no well-defined crystral structure of their own and containing high concentrations of individual silicon or manganese atoms. The precipitates increase the strength of the alloy by developing coherency strains at the interface between the matrix and the growing aggregates.

Strengthening precipitates may also result from the presence of the elements molybdenum, titanium, copper, aluminum, or combinations thereof. Additionally, chromium, nickel, iron, and combinations thereof may also be found in the strengthening precipitates.

Chromium and nickel are added to promote corrosion resistance. Chromium is a strong ferrite stabilizer and is utilized to convert the composition to an austenite microstructure at a moderately low temperatures. At lower concentrations, nickel provides for the formation of the austenite microstructure at the temperature at which the composition is annealed. At higher concentrations, nickel also facilitates the transformation of the austenite structure to martensite when the composition is quenched or cold worked.

Cobalt is optional but may be employed to enhance the formation of precipitates. Tantalum, niobium, vanadium, and tungsten are limited to less than about 0.1% each. The balance is iron, and customary impurities in amounts up to about 0.5% total. In the broad range, iron will be present in an amount of at least 50% and in the preferred range in an amount of at least 65%.

The above-described material is melted and solidified according to conventional steel making techniques taking care that the resultant material is homogenous and free from porosity and inclusions. The starting material is then processed, preferably by hot rolling, to an intermediate thickness which is selected so that the subsequent required amount of cold rolling produces a sheet or strip having a thickness appropriate for use in razor blades.

Because the above-identified material is originally processed by hot working in the austenite range and is then cooled, some of the precipitate forming materials (titanium, aluminum, copper, silicon, manganese, and molybdenum) will be in a non-equilibrium-supersaturated condition. There is a thermodynamic driving force which tends to move the supersaturated elements in the direction of equilibrium by causing the nucleation and growth of particles which provide increased strength and hardness. But the nucleation and growth processes which produce the particles are extremely slow at temperatures below about 300 degrees C.

Following the cold rolling step, strengthening precipitates are formed by heat treatment at temperatures between 300 degrees C. and 650 degrees C. for a time of between 1 minute and 20 hours. Preferably, the temperature range is between about 420 degrees C. and 500 degrees C. and the time is between about 2 minutes and 10 hours. The resultant microstructure comprises a matrix having a largely martensitic structure containing strengthening particles based on at least one of Ti, Al, Cu, Si, or Mo.

In addition, the resultant material will have a thickness appropriate for use in razor blade applications, and a hardness in excess of about 600 HV (measured at 1 Kg) and preferably between about 620 HV and 800 HV (measured at 1 Kg), and will have substantial corrosion resistance as the result of the presence of a substantial amount of chromium (preferably more than about 9%) and nickel in the matrix.

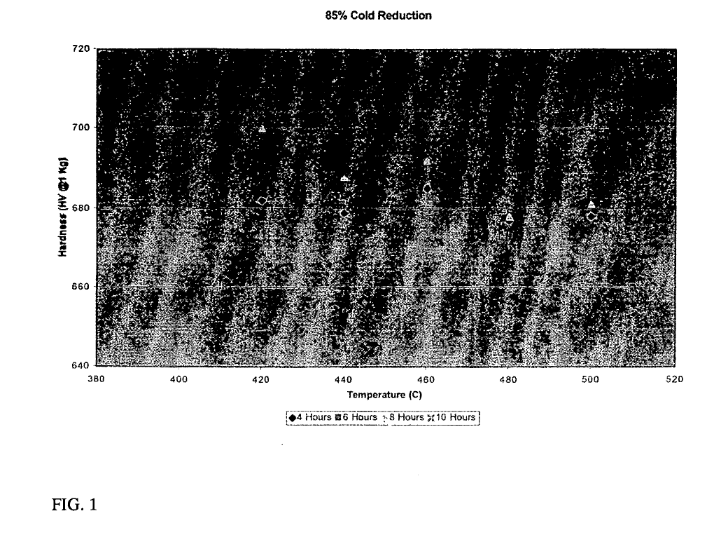

The ultimate hardness of the material is dependant upon, among other things, the extent of the cold reduction, the heat treat temperature for any post cold reduction heat treatment, and the amount of time during which the material is held at the heat treat temperature. Referring now to FIG. 1, the hardness achieved for different heat treat cycles for 85% cold reduced material is shown graphically at 10. Each heat treat cycle (four-, six-, or eight hour cycle) ranges from 420 degrees C. to 500 degrees C. As indicated by point 12, the greatest hardness value for the materials tested was approximately 700 HV when the material was held at 420 degrees C. for eight hours. For similarly treated samples (the eight hour samples), the hardness is compromised as the temperature is increased. For the six- and four hour samples, the hardness measured is correspondingly less, but the hardness appears to remain stable as the temperature is increased.

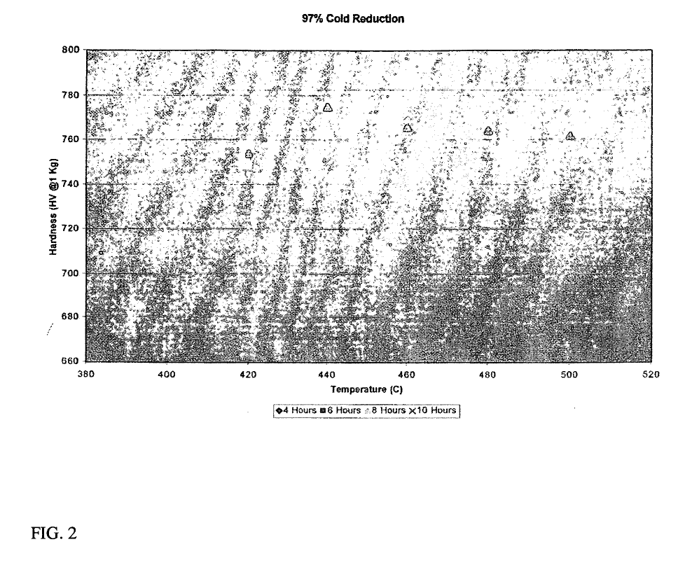

Referring now to FIG. 2, the hardness achieved for different heat treat cycles for 97% cold reduced material is shown graphically at 20. As above, each heat treat cycle ranges from 420 degrees C. to 500 degrees C. As indicated by point 22, the greatest hardness value with 97% cold reduction was approximately 785 HV when the material was held at 440 degrees C. for 4 hours. For all 97% cold reduced material samples treated above 440 degrees C., the hardness values of the four- and eight hour samples declined slightly and stabilized at about 770 HV and 760 HV, respectively. The hardness of the six hour sample at 480 degrees C. appeared to increase.

A sharpened edge may be produced on the razor blade made from the above-described material by using conventional grinding techniques. The sharpened edge may be coated with one or more layers of conventional coatings including, but not limited to chromium and alloys based on chromium, various precious metals (including, but not limited to, platinum, rhodium, iridium, and osmium), alloys based on chromium and precious metals and mixtures thereof, ceramics, diamond-like carbon, amorphous diamond, and polymers such as Teflon™, Krytox 1000™, and Dryfilm LXE™.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A razor blade for use in a wet shave razor, comprising:
a ferrous material containing less than about 0.1% carbon and having a hardness in excess of 600 HV.

2. A razor blade for use in a wet shave razor as defined by claim 1, having a hardness of from about 620 HV to about 800 HV and containing more than about 7% chromium in solid solution.

3. A razor blade for use in a wet shave razor as defined by claim 1, wherein the hardness of the ferrous material is approximately 800 HV and where the material contains more than about 7% chromium in solid solution.

4. A razor blade for use in a wet shave razor as defined by claim 1, wherein the ferrous material is 85% cold reduced and has a hardness of approximately 700 HV.

5. A razor blade for use in a wet shave razor as defined by claim 1, wherein the ferrous material is approximately 97% cold reduced and has a hardness of about from 700 HV to 800 HV.

6. A ferrous steel composition for use in a razor blade, said composition comprising:
less than about 0.015% carbon; and
at least one element selected from the group consisting of chromium and nickel;
wherein said at least one element selected from the group consisting of chromium and nickel is present as a corrosion resistant agent.

7. A ferrous steel composition as defined by claim 6, further comprising at least one element selected from the group consisting of silicon, manganese, molybdenum, titanium, copper, and aluminum, wherein said at least one element is present as a strengthening agent and is precipitated during the formation of said steel.

8. A ferrous steel composition as defined by claim 6, further comprising at least one element selected from the group consisting of cobalt, tantalum, niobium, vanadium, and tungsten.

9. A ferrous steel composition as defined by claim 6, wherein said carbon is less than about 0.010%.

10. A ferrous steel composition as defined by claim 6, wherein said less than about 0.015% carbon is exclusive of any carbon bound in a carbide in said ferrous steel.

11. A ferrous steel composition as defined by claim 6, wherein said chromium, if present, is about 11.5% to about 12.5%.

12. A ferrous steel composition as defined by claim 6, wherein said nickel, if present, is about 8.75% to about 9.75%.

13. A method of producing a razor blade for use in a wet shave razor, said method comprising the steps of:
providing a starting material having a composition of 0.1% maximum by weight of C, 0.7% maximum by weight of Si, 1.0% maximum by weight of Mn, between about 10% to about 14% by weight of Cr, between about 7% to about 11% by weight Ni, between about 0.5% to about 0.6% by weight of Mo, between about 0.4% and about 1.4% by weight of Ti, between about 0.5% to about 4% by weight of Cu, between about 0.5% to about 0.6% by weight of Al, between about 0% to about 0.9% by weight of Co, 0.1% maximum by weight of N, 0.1% maximum by weight of Ta, 0.1% maximum by weight Nb with the balance of the material being Fe including impurities up to about 0.5% by weight;
said starting material being in the cold worked condition, and being in a non-equilibrium or supersaturated condition with respect to at least one of Ti, Al, Cu, Si, or Mo;
cold rolling said starting material a total of at least 60% reduction in thickness; and
heat treating said cold rolled material at a temperature of from about 300 degrees C. to about 650 degrees C. to cause the formation of a dispersion of strengthening precipitates containing at least one of Ti, Al, Cu, Si or Mo whereby the hardness of the material will be increased to at least 600 HV; and
forming a sharpened edge on said material.

14. A method as defined by claim 13, wherein said starting material has a microstructure which comprises at least 50% by volume austenite, balance martensite, and strengthening precipitates containing at least one element selected from the group consisting of Ti, Al, Cu, Si, Mo, and mixtures thereof.

15. A method as defined by claim 13, wherein, after cold rolling, the structure of said material contains at least 70% by volume martensite.

16. A method as defined by claim 13, further comprising coating the sharpened edge with at least one layer of a material selected from the group consisting of chromium, platinum, rhodium, osmium, iridium, alloys based on chromium, platinum, rhodium, osmium and mixtures thereof, ceramics, diamond-like carbon, amorphous diamond, and polymeric materials.

17. A method as defined by claim 13, wherein said step of cold rolling includes:
cold rolling the starting material to approximately an 85% reduction in thickness, heat treating the cold rolled material at a temperature of approximately 420 degrees C. for 8 hours to cause the formation of a material having a hardness of approximately 700 HV.

18. A method as defined by claim 13, wherein said step of cold rolling includes:
cold rolling the starting material to approximately a 97% reduction in thickness, heat treating the cold rolled material at a temperature of 440 degrees C. for 4 hours to cause the formation of a material having a hardness of approximately 785 HV.
